(19) United States
(12) Patent Application Publication
(10) Pub. No.: US 2023/0265670 A1
(43) Pub. Date: Aug. 24, 2023

(54) RAISED FLOOR PANEL REMOVAL TOOL

(71) Applicant: Marcus Jordon Jones, Daytona Beach, FL (US)

(72) Inventor: Marcus Jordon Jones, Daytona Beach, FL (US)

(21) Appl. No.: 17/678,292

(22) Filed: Feb. 23, 2022

(51) Int. Cl. E04G 23/00; B66F 15/00

(52) U.S. Cl. CPC E04G 23/006; B66F 15/00

(57) ABSTRACT

A raised floor panel removal tool includes a J-shaped body having a first vertical bar, a second vertical bar and a horizontal bar that is connected to the vertical bars along the respective bottom ends. A handle is positioned along the top of the first vertical bar and is positioned perpendicular to the horizontal bar. The tool components are constructed from steel tubing and an electrically insulative material is provided along the handle. A pair of wheels are attached to the bottom end of the first vertical bar by a bracket, and the second vertical bar can be constructed to include an adjustable height.

### TECHNICAL FIELD

The present invention relates generally to flooring installation and removal tools, and more particularly to a tool for removing panels from a raised floor system.

### BACKGROUND

The statements in this section merely provide background information related to the present disclosure and may not constitute prior art.

Raised floors are commonly used where large numbers of computers are operating such as data rooms, and call centers, for example. Typical raised floor systems utilize a plurality of individual panels that are positioned along a frame to create a space between the sub-floor and the normal working environment of the room. As the name implies, the sub-floor is the surface that would serve as the floor of the data center prior to the installation of a raised flooring system. The space created by such systems typically includes a height of between 6 and 12 inches and are used to house any number of different components such as electrical wiring, telephone wiring, computer cables, and/or HVAC components, for example which are needed but are more safely or conveniently enclosed in an area apart from the main area of the data center room.

Although the primary purpose of the raised flooring system is to structurally support an applied load, the space between the floors must be accessed periodically for maintenance, repairs, installation and/or replacement of certain components. To this end, it is important that certain of the individual panels be removeable to provide access to this area. Although there are known tools for removing lightweight floor panels of less than 50 pounds using suction cups attached to a handle, these systems are not able to be used with heavy duty floor systems (e.g., individual panels weighing more than 50 pounds) whose panels are constructed from steel, ceramic or concrete, for example. Indeed, the most difficult aspect of removing these panels is the ability to engage and lift the panel from its horizontal resting position so that it can be removed.

Moreover, depending on the size of the room and the location of the components which must be accessed, it is not uncommon for a worker to have to engage, lift and remove multiple panels at one time. During this period, the normal operation of the room is interrupted which costs the operations company time and money. In some instances, this can be tens of millions of dollars. Accordingly, it would be beneficial to provide a raised floor panel tool that allows workers to quickly engage and lift a portion of a floor panel so the same can be removed, without suffering from the drawbacks described above.

### SUMMARY OF THE INVENTION

The present invention is directed to a tool for removing raised flooring panels. One embodiment of the present invention can include a generally J-shaped body having a first vertical bar, a second vertical bar and a horizontal bar that is connected to the vertical bars along the respective bottom ends. A handle is positioned along the top of the first vertical bar and is positioned perpendicular to the horizontal bar.

In one embodiment, the tool components can be constructed from steel tubing and can be joined together by a plurality of steel tube elbows and a T-shaped connector. In this embodiment, the handle can include an electrically insulative material such as rubber grips for protecting a user from electrical shock and for aiding in manipulating the tool.

In one embodiment, the tool can also include a pair of wheels that can be attached to the bottom end of the first vertical bar by a bracket. The wheels and bracket can function to aid a user in rotating the tool during operation. In one embodiment, the second vertical bar can include an adjustable height so as to permit the tool to be used with raised floor systems having any number of different heights from the sub floor.

This summary is provided merely to introduce certain concepts and not to identify key or essential features of the claimed subject matter.

### BRIEF DESCRIPTION OF THE DRAWINGS

Presently preferred embodiments are shown in the drawings. It should be appreciated, however, that the invention is not limited to the precise arrangements and instrumentalities shown.

FIG. 1 is a perspective view of a raised floor panel removal tool that is useful for understanding the inventive concepts disclosed herein.

FIG. 2 is another perspective view of the raised floor panel removal tool, in accordance with one embodiment of the invention.

FIG. 3A is a perspective view of the raised floor panel removal tool in operation, in accordance with one embodiment of the invention.

FIG. 3B is another perspective view of the raised floor panel removal tool in operation, in accordance with one embodiment of the invention.

### DETAILED DESCRIPTION OF THE INVENTION

While the specification concludes with claims defining the features of the invention that are regarded as novel, it is believed that the invention will be better understood from a consideration of the description in conjunction with the drawings. As required, detailed embodiments of the present invention are disclosed herein; however, it is to be understood that the disclosed embodiments are merely exemplary of the invention which can be embodied in various forms. Therefore, specific structural and functional details disclosed herein are not to be interpreted as limiting, but merely as a basis for the claims and as a representative basis for teaching one skilled in the art to variously employ the inventive arrangements in virtually any appropriately detailed structure. Further, the terms and phrases used herein are not intended to be limiting but rather to provide an understandable description of the invention.

### Definitions

As described throughout this document, the term “about” “approximately” “substantially” and “generally” shall be used interchangeably to describe a feature, shape or measurement of a component within a tolerance such as, for example, manufacturing tolerances, measurement tolerances or the like.

As described herein, the term “removably secured,” and derivatives thereof shall be used to describe a situation wherein two or more objects are joined together in a non-permanent manner so as to allow the same objects to be repeatedly joined and separated.

As described throughout this document, the term “complementary shape,” and “complementary dimension,” shall be used to describe a shape and size of a component that is identical to, or substantially identical to the shape and size of another identified component within a tolerance such as, for example, manufacturing tolerances, measurement tolerances or the like.

As described herein, the term “connector” includes any number of different elements that work alone or together to repeatedly join two items together in a nonpermanent manner. Several nonlimiting examples include opposing strips of hook and loop material (i.e., Velcro®), attractively-oriented magnetic elements, flexible strips of interlocking projections with a slider (i.e., zipper), a thin, flexible strap with a notched surface and one end threaded through a locking mechanism (i.e., zip tie) at the other, tethers, buckles such as side release buckles, and compression fittings such as T-handle rubber draw latches, hooks, snaps and buttons, for example. Each illustrated connector and complementary connector can be permanently secured to the illustrated portion of the device via a permanent sealer such as glue, adhesive tape, or stitching, for example.

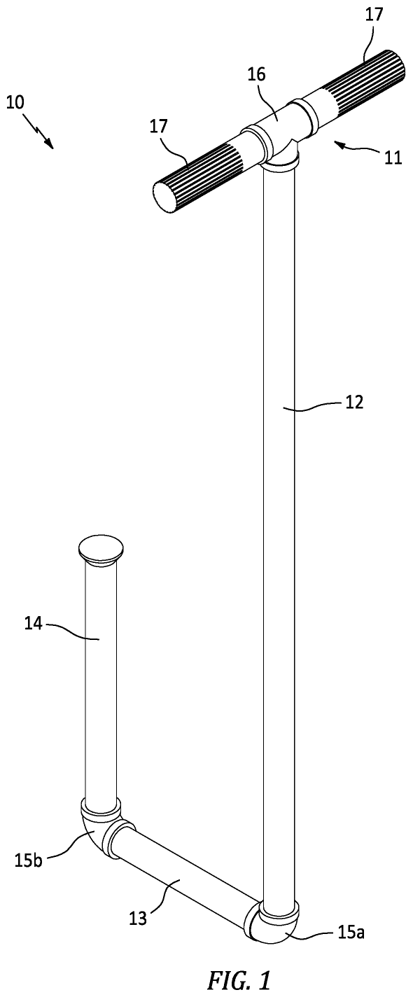

FIGS. 1-3B illustrate one embodiment of a raised floor panel removal tool 10 that are useful for understanding the inventive concepts disclosed herein. In each of the drawings, identical reference numerals are used for like elements of the invention or elements of like function. For the sake of clarity, only those reference numerals are shown in the individual figures which are necessary for the description of the respective figure. For purposes of this description, the terms “upper,” “bottom,” “right,” “left,” “front,” “vertical,” “horizontal,” and derivatives thereof shall relate to the invention as oriented in FIG. 1.

As shown in the drawings, the tool 10 can include a generally J-shaped main body member having a handle 11, a first vertical bar 12, a horizontal bar 13 and a second vertical bar 14. The first and second vertical bars can be positioned parallel to each other and can be connected along their respective bottom ends by the horizontal bar. Likewise, the handle 11 can be oriented generally perpendicular to the horizontal bar 13.

In one embodiment, each of the handle 11 and the bars 12-14 can be constructed from steel round tube and can be removably joined together by connectors such as steel tube elbows 15a/15b and a steel tube T-connector 16, for example. Of course, the main body is not limited to this construction material, as other embodiments are contemplated wherein different materials are used and/or wherein the tool components are permanently joined together and/or include a unitary construction.

Several nonlimiting examples of possible construction materials also include but are not limited to various other types of metals or metal alloys (e.g., aluminum, titanium, or alloys thereof), various plastic/polymers (e.g., high-density polyethylene (HDPE), rigid polyvinyl chloride (PVC), or polyethylene terephthalate (PET)), and/or various composite materials (e.g., carbon fibers in a polymer matrix, etc.). Moreover, other embodiments are contemplated wherein the main body is constructed from a single piece of material that is formed or molded into the described shape.

Because the tool will preferably be constructed from steel, the preferred embodiment of the tool can include an electrically insulative material 17 such as rubber, for example that is provided along the handle 11. The use of rubber grips on the handle functioning to insulate the worker from a possible electrical shock should the device encounter a live electrical wire, while advantageously and simultaneously improving the ability of the worker to grip and manipulate the tool.

Because raised floor panels are typically suspended between 6 and 12 inches from the sub floor, and the device 10 functions as a fulcrum to lift the panels, the dimensions of the device are important. To this end, the device can preferably include the following dimensions: first vertical pipe 12 having a height (e.g., distance between connectors 15a and 16) of approximately 54 inches; horizontal pipe 13 having a length (e.g., distance between connectors 15a and 15b) of approximately 12 inches; and second vertical pipe 14 having a height (e.g., distance between connector 15b and distal end) of approximately 12 inches. Such dimensions being chosen specifically to engage floor sections located 6 inches to 12 inches from the sub floor. Of course, any number of other dimensions are also contemplated.

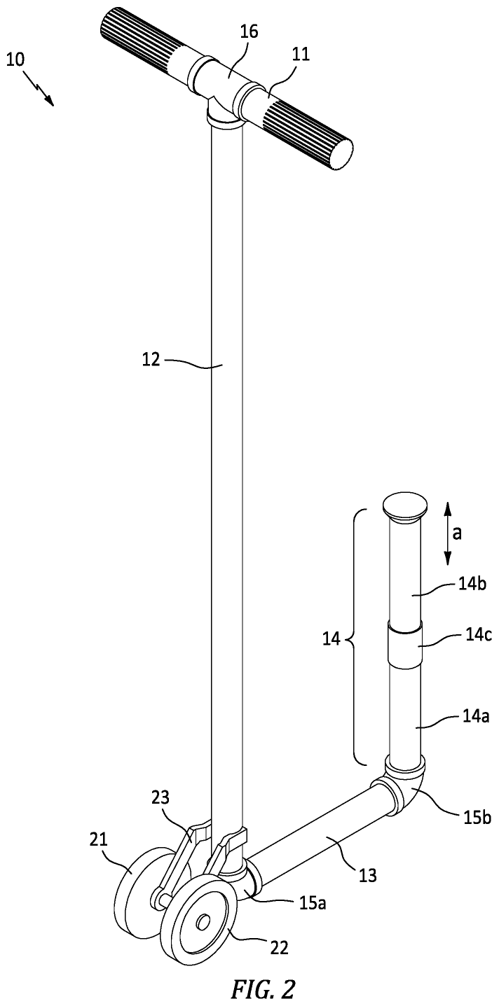

As shown at FIG. 2, one embodiment of the device 10 can also include a pair of wheels 21 and 22 that are mounted along the bottom portion of the vertical bar 12 by a bracket 23 or other such connector. The wheels advantageously allowing a user to roll the device from one panel to the next, while aiding in using the device as a fulcrum to lift panels as will be described below.

As is also shown at FIG. 2, the second horizontal bar 14 can be telescopic in nature, so as to allow the user to adjust the height of the same. To this end, the horizontal bar can include a fixed bar section 14a that is secured to the horizontal bar, and a sliding bar section 14b that extends from and retracts into the fixed bar section 14a (see arrow A). A tensioning ring 14c can be provided along the end of the fixed bar section and acts to secure the sliding bar section at a user defined height.

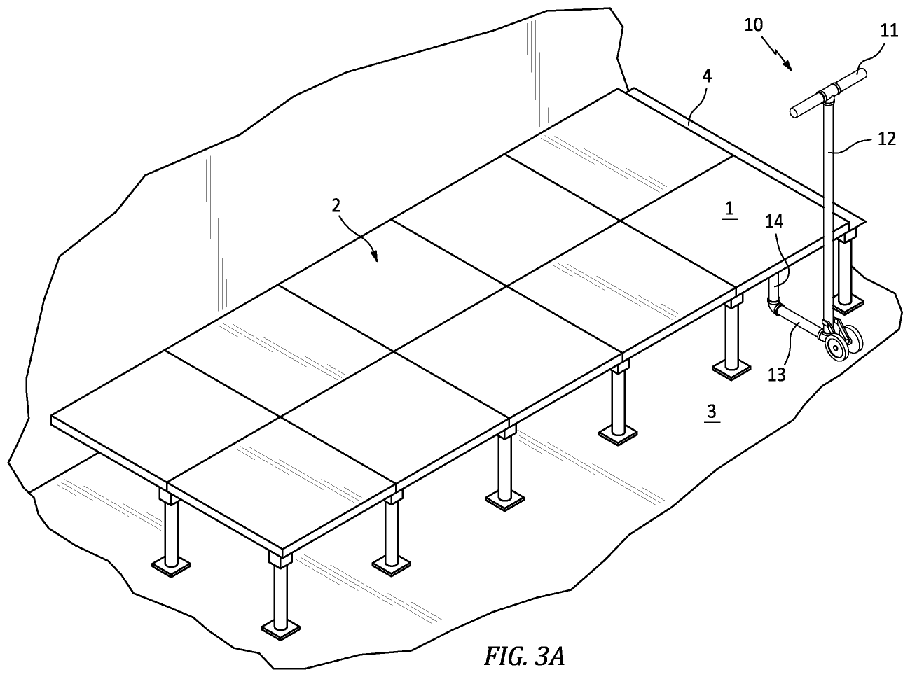

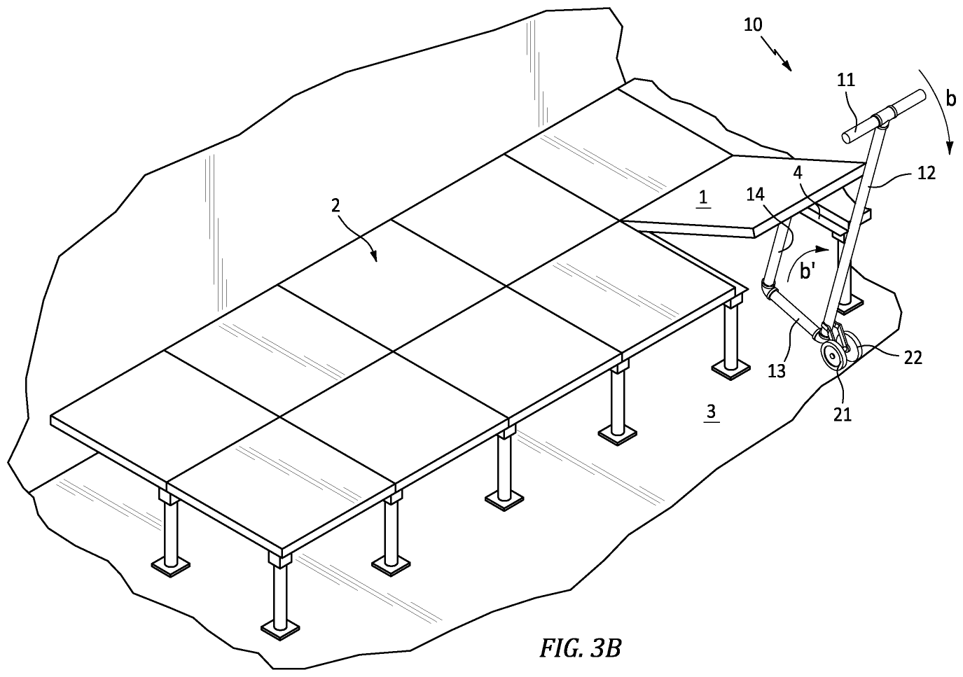

FIGS. 3A and 3B illustrate one embodiment of the tool 10 in operation. As shown, the tool can be positioned such that the second vertical bar 14 is located beneath one of the floor tiles 1 of a removable floor system 2. As shown by arrows b and b′, when the handle 11 is pulled/rotated backward the wheels 21/22 (or the connector 15a for devices without wheels) will engage the sub floor 3 and will act as a fulcrum that moves the second vertical bar 14 upward whereby it will lift the panel 1. When so positioned, another user can grasp the panel by the edges and remove the same from the platform frame 4.

Accordingly, the above-described tool functions to quickly and easily engage and lift removable floor panels in a novel manner.

As described herein, one or more elements of the raised floor panel removal tool 10 can be secured together utilizing any number of known attachment means such as, for example, screws, glue, compression fittings and welds, among others. Moreover, although the above embodiments have been described as including separate individual elements, the inventive concepts disclosed herein are not so limiting. To this end, one of skill in the art will recognize that one or more individually identified elements may be formed together as one or more continuous elements, either through manufacturing processes, such as welding, casting, or molding, or through the use of a singular piece of material milled or machined with the aforementioned components forming identifiable sections thereof.

As to a further description of the manner and use of the present invention, the same should be apparent from the above description. Accordingly, no further discussion relating to the manner of usage and operation will be provided.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Likewise, the term “consisting” shall be used to describe only those components identified. In each instance where a device comprises certain elements, it will inherently consist of each of those identified elements as well.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

1. A tool, comprising:
a first vertical bar having a top end and a bottom end;
a second vertical bar having a top end and a bottom end; and
a horizontal bar having a first end that is secured to the bottom end of the first vertical bar, and a second end that is secured to the bottom end of the second vertical bar; and
a handle that is connected to the top end of the first vertical bar.

2. The tool of claim 1, wherein the first vertical bar and the second vertical bar are positioned parallel to each other.

3. The tool of claim 2, wherein the handle is positioned perpendicular to the horizontal bar.

4. The tool of claim 1, wherein each of the first vertical bar, the second vertical bar and the horizontal vertical bar are constructed from steel tubes.

5. The tool of claim 4, further comprising:
a first elbow that connects the first end of the horizontal bar to the bottom end of the first vertical bar.

6. The tool of claim 5, further comprising:
a second elbow that connects the second end of the horizontal bar to the bottom end of the second vertical bar.

7. The tool of claim 6, further comprising:
a T-connector that connects the handle to the top end of the first vertical bar.

8. The tool of claim 7, wherein each of the first elbow, the second elbow and the T-connector comprise a steel tube construction.

9. The tool of claim 8, further comprising:
an electrically insulative material that is disposed along the handle.

10. The tool of claim 1, further comprising:
a bracket that is positioned along the bottom end of the first horizontal bar.

11. The tool of claim 10, further comprising:
a pair of wheels that are connected to the bracket.
